(19) United States
(12) Patent Application Publication
(10) Pub. No.: US 2016/0132567 A1
(43) Pub. Date: May 12, 2016

(54) MULTI-SEARCH AND MULTI-TASK IN SEARCH

(71) Applicant: Microsoft Corporation, Redmond, WA (US)

(72) Inventors: Daniel Dole, Seattle, WA (US); Tracy Childers, Sammamish, WA (US); Romualdo Impas, Seattle, WA (US); Donald A. Barnett, Monroe, WA (US); Yekaterina Grabar, Seattle, WA (US); Dvir Horovitz, Redmond, WA (US); Derek R. Westcott, Kirkland, WA (US); Sudhakar Pitchumani, Issaquah, WA (US); Srinivas Kanakapally, Bothell, WA (US); Priya Dandawate, Seattle, WA (US); Karl Eberhard Tolgu, Seattle, WA (US)

(73) Assignee: Microsoft Corporation, Redmond, WA (US)

(21) Appl. No.: 14/539,986

(22) Filed: Nov. 12, 2014

(51) Int. Cl. G06F 17/30; G06F 3/0482

(52) U.S. Cl. CPC G06F 17/30554; G06F 17/30241; G06F 17/30011; G06F 3/0482

(57) ABSTRACT

Map multi-search architecture that enables users to multi-task on the mapping engine website. A card interaction model enables the creation of new cards for new tasks and from which users can retrieve previous results without needing to redo the search task. One or more cards can be retrieved by scrolling through and selecting the desires card(s). Point-of-interest (POI) capabilities of the architecture introduce different POI colors, POI sizes, and a decay model which enables users to differentiate between different sets of results and furthermore, enables users to see the proximity of different sets of results. The POI system enables differentiated POI sets for different sets of search results and/or detail cards.

### BACKGROUND

Search engines typically do not enable the user to retain different types of tasks, such as multiple sets of search results. If a user performs a new search following a previous search, the user loses the previous search results. For example, when the user searches for directions to a location, and then conducts another search, the user loses the results for the directions.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed map multi-search and multi-task architecture enables users to multi-task on a mapping engine. As a system implementation, the system can comprise a generation component configured to generate interactive virtual documents of search results and result tasks for a mapping query, the virtual documents relate to points-of-interest (POIs) identified on the interactive map.

The system can further comprise a visual component configured to present the virtual documents in a viewport in combination with an interactive map, and apply visual emphasis to each of the points-of-interest of the interactive map and corresponding virtual documents such that the POIs are visually differentiated on the interactive map and each point-of-interest is visually identified with a corresponding virtual document using the visual emphasis. The virtual documents and visual emphasis can be provided for improved user efficiency and interaction performance. A retrieval component is provided and configured to retrieve and enable presentation of one or more of the search sessions and associated virtual documents for user interaction.

The system can further comprise an update component configured to update associated interactive virtual documents in response to a change made to the interactive map and to update the interactive map in response to a change made to one or more of the associated interactive virtual documents.

The visual component can be configured to present virtual documents concurrently with the corresponding interactive map to enable visual perception and comparison of document content of a virtual document of search results, a virtual document of a result task, and corresponding point-of-interest.

The system can further comprise a decay algorithm configured to control a number of the points-of-interest presented on the interactive map using time decay to remove features presented on the map. The decay algorithm can be configured to retain a point-of-interest on the interactive map in accordance with a permanence rule.

The retrieval component can be configured to enable rendering of a previously decayed point-of-interest on the map by bringing into focus a virtual document associated with the previously decayed point-of-interest. The points-of-interest are represented as map objects differentiated by size and color. Additionally, the visual component can be configured to enable comparison of two or more of the virtual documents of a same session or a different session.

In terms of a method the implements the virtual documents as cards, a method is provided comprising acts of: generating a virtual interactive search card of search results in response to a mapping query, the virtual search card displays the search results as interactive card content; generating a virtual interactive task card in response to selection of a search result of the search card, the task card displaying content related to the selected search result; presenting both the search card and the task card concurrently with an interactive map of points-of-interest, the search card and task card visually related to the points-of-interest, for improved interaction performance; and updating the search card in response to a change related to the interactive map and updating the interactive map in response to a change related to the search card, for improved user efficiency.

The architecture, in terms of a card interaction model, enables the creation of a new card for each new task and from which users can retrieve previous results without needing to redo the search task. One or more cards can be retrieved by scrolling through and selecting the desires card(s).

The POI capability of the architecture introduces different POI colors, POI sizes, and a decay model which enables users to differentiate between different sets of results, and furthermore, enables users to view the proximity of different sets of results. For example, if a user is planning a trip, and initially searches for hotels, followed by restaurants, followed by museums, the architecture enables the user to see POIs for these result sets on the map and determines the proximities to one another, thereby assisting the user in making decisions about which places to visit. The POI system enables differentiated POI sets for different sets of search results and/or detail cards. As previously indicated, the POI can be differentiated in many different ways (e.g., by color, size, etc.).

The map multi-search and multi-task architecture enables users to achieve multiple different activities on the mapping website. Users can conduct multiple searches and retain multiple sets of results for these searches. For example, users can search multiple sets of directions and multiple sets of POI entities, and retain those results (tasks) for interactive viewing and comparison, as well as other user-desired actions (e.g., comparing travel times between at least the two different modes (e.g., directions and POI search).

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an alternative implementation of a system that further includes the capabilities for updates and feature decay.

FIG. 3 illustrates an alternative system in accordance with the disclosed architecture described in terms of virtual documents as cards.

FIG. 4 illustrates a method in accordance with the disclosed architecture.

FIG. 5 illustrates an alternative method in accordance with the disclosed architecture.

FIG. 6 illustrates yet another alternative method in accordance with the disclosed architecture.

FIG. 7 illustrates a block diagram of a computing system that executes map multi-search in accordance with the disclosed architecture.

### DETAILED DESCRIPTION

In an existing mapping search engine only a maximum number of results (e.g., ten) for a particular search can be shown and results for multiple searches may be accessible via tabs. Moreover, there does not appear to be a decay model where certain features are phased out of view thereby enabling the user to perform unlimited searches and have unlimited sets of different points-of-interest (POIs). For example, the user is not allowed to conduct multiple tasks, such as further to include “Directions” (e.g., searching driving directions from point A to point B). The user cannot get directions from point A to point B and then be able to compare the directions between the two different POIs. Thus, when the user receives transit directions, the driving directions are lost.

The disclosed multi-search and multi-task search architecture enables users to perform multiple same or different activities in a search environment (e.g., on a mapping website). Users can conduct multiple searches and retain multiple sets of results for these searches. In application to a mapping engine, for example, users can search multiple sets of directions and multiple sets of POI (point-of-interest), and retain those results for interactive viewing and comparison, as well as other user-desired actions (e.g., comparing travel times between the two different modes).

Users can also conduct different types of tasks, which are then maintained. For example, the user can search for a restaurant, and then perform a task relevant to the restaurant such as search new directions from a current location to the restaurant, while not losing the restaurant search results.

The search results and/or tasks can be presented as virtual interactive documents (e.g., cards) in the same viewport as the interactive map. Thus, the user can interact to select a search result on a search virtual document, to then be presented with a task virtual document that presents related information to the POI result and/or enables the user to further the perform additional tasks.

The search results and/or tasks can be presented to the user in the same or different interfaces such as windows, as a ring virtual representation, card, flyout window(s), pop-up window, and other types of user interfaces.

As relates to map multi-search and multi-task capabilities, the architecture introduces a card interaction model that enables users to have generated and saved multiple cards (a virtual object as a self-contained unit of session data) for a single or multiple search sessions that can be retrieved by way of, for example, scrolling through the cards and selecting one or more of the cards.

The architecture also introduces a POI system that enables differentiated POI sets for different sets of search results or detail cards. The POI can be visually differentiated using many different techniques, such as by object color and size. The POI system also provides a decay model that enables users to differentiate between different sets of results and to see the physical (geographic) proximity of different sets of results. For example, when planning a trip and search for POIs such as hotels, then restaurants, then museums, the user be presented with the POIs for these result sets on the map and visually and/or programmatically determine the proximity to one another, which may assist the user to make decisions about which places (e.g., points-of-interest—POIs) to visit.

Users can perform multiple sets of directions (e.g., searching driving directions from point A to point B, then searching transit system (e.g., rail, bus, etc.) directions from the same point A to same point B, and then comparing the travel times between the two different points).

In one implementation of the POI system, each search has an assigned POI color (e.g., there can be three colors that are cycled). The POI decay system provided manages the amount of POIs on a map. The user can get back (return) to a decayed POI by scrolling back to the corresponding card. There can be provided permanence rules that apply for what are considered more relevant or important POI that the user chooses to retain (e.g., view in each map view).

In addition to color, the POIs can also differentiated by object size (e.g., three different sizes). The size can be made dependent on POI selection and the state of the card (e.g., an in-focus card or and out-of-focus card) and the location of the POI on the card (e.g., the page is in view or out of view).

The architecture generates and maintains is a direct relationship between a card and a POI (re-query can be initiated according to a change in map view), the colors are matched between the POI and card, and the state of the card/POI is reflective of the each other. Additionally, routes follow a decay system that is independent of the POI decay system.

Other features can include, but are not limited to, re-distributing colors or other visual emphasis based on the deletion of a card; however, the POI from different searches will always be presented as distinguishable. Rules related to card deletion can be the following: when deleting and in-focus card, move card focus to a subsequent card. Alternatively, if Head is in-focus and deleted, then focus shifts to the previous card. Deleting a nearby card can result in the POI updating to different colorization layouts.

The coloration aspect can also be linked to relevance instead of cards. The POI can be made to change as the user pulls a different card into focus. A legend can be employed and anchored in the view to assist the user in recalling the assigned colorations, not only for the POI in a map, but also for visually identifying search results (e.g., a bounding box having a boundary of the related color).

In one implementation, panning the map and selecting a previous card can be made to automatically trigger a search of the old query on the new map view. Tips can also be presented to assist the user in making decisions related to the current state of the map, POIs, and/or cards.

Searches within the same geographical region are treated as dependent on each other. Searches in a new geographical region (e.g., the query changes the map view) mark a virtual document as independent of the previous search. Additionally, panning the map implies a dependency on a previous virtual document. Thus, searches may or may not be dependent on each other.

Other types of virtual documents (e.g., cards) can be a “favorites” card that can be retrieved or automatically presented to show the user-designated favorite places and/or tasks.

While associating colors with cards (virtual documents) can be used, in another implementation, color can be associated with relevance. This leads to a simpler mental model; the most relevant POIs can always be a specific color, and less relevant POIs as correspondingly different color(s). Moreover, deleting a virtual document re-distributes the colors. Deleting an in-focus card automatically moves focus to a subsequent card. Focus can also be shifted to a previous card, if desired.

POIs from different searches are made distinguishable. A legend can be employed (e.g., anchored at the bottom of a card “lane” (the scrolling area in which the cards are enabled for scrolling)) to assist the user in recalling color denotations or meanings Cards in the card lane can be linked using a virtual link lock implemented by the user. Linking two or more cards creates a card stack (or collection) for those cards. Removing the link lock splits those cards into different stacks.

Visual objects such as link locks can enable the user to combine (e.g., append) card sets (or stacks). In reverse, removing the link creates new stacks of cards for the unlinked card stacks. As the user moves the map (e.g., drags the map to a different center view), the card stacks will adjust accordingly to automatically refresh the results.

A location can be implicitly locked to a card. Thus, re-doing a search for one card does not affect the search of another card in the set.

Card scrolling can employ a snap feature that once triggered, automatically positions the associated card to a predefined location on the screen. Scrolling to the bottom of a card that is in-focus, snaps the newer card into focus. Scrolling beyond the top of the card currently in-focus snaps the older card into focus. Cards snap in the same direction of scrolling.

Card “peeking” can be enabled such that the user is presented with a small portion of a next card sufficient enough to give the user some indication as to the card identity or content.

User interaction with objects of the mapping user interface can be gesture-enabled, whereby the user employs one or more gestures for interaction. For example, the gestures can be natural user interface (NUI) gestures. NUI may be defined as any interface technology that enables a user to interact with a device in a “natural” manner, free from artificial constraints imposed by input devices such as mice, keyboards, remote controls, and the like. Examples of NUI methods include those methods that employ gestures, broadly defined herein to include, but not limited to, tactile and non-tactile interfaces such as speech recognition, touch recognition, facial recognition, stylus recognition, air gestures (e.g., hand poses and movements and other body/appendage motions/poses), head and eye tracking, voice and speech utterances, and machine learning related at least to vision, speech, voice, pose, and touch data, for example.

NUI technologies include, but are not limited to, touch sensitive displays, voice and speech recognition, intention and goal understanding, motion gesture detection using depth cameras (e.g., stereoscopic camera systems, infrared camera systems, color camera systems, and combinations thereof), motion gesture detection using accelerometers/gyroscopes, facial recognition, 3D displays, head, eye, and gaze tracking, immersive augmented reality and virtual reality systems, all of which provide a more natural user interface, as well as technologies for sensing brain activity using electric field sensing electrodes (e.g., electro-encephalograph (EEG)) and other neuro-biofeedback methods.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

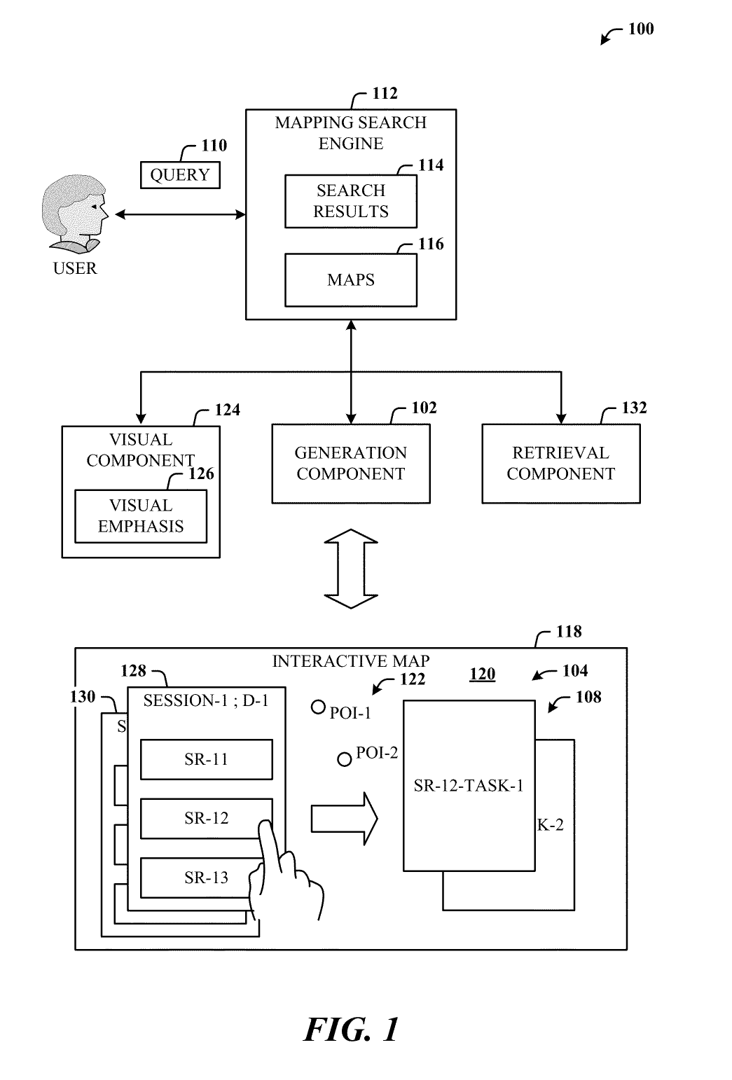

FIG. 1 illustrates a system 100 for multiple searches in a map environment. The system 100 comprises a generation component 102 configured to generate interactive virtual documents 104 of search results 106 and result tasks 108 for a mapping query 110. The mapping query 110 can be input to a mapping search engine 112 that can be configured to return both search results 114 and maps 116 related to the search results 114. Alternatively, the results 114 can be searched and returned using a typical search engine and the maps 116 can be searched and returned using the mapping search engine.

The search results 114 can be points-of-interest (POIs) relevant to the query 110, and the maps 116 can show the points-of-interest in a geographical area. For example, if the query is “pizza places in Bellevue”, the results 114 can include a listing of some or all pizza places in Bellevue and corresponding maps 116 showing the pizza places mentioned in the search results 114.

The virtual documents 104 can be presented in any suitable format (e.g., virtual card, word processing document, office suite document, etc.) in a viewport 118 (a viewing region having boundaries defined by an application) in combination with an interactive map 120. The virtual documents 104 relate to points-of-interest (POIs) 122 (e.g., POI-1, POI-2, etc.) presented and identified on the interactive map 120.

A visual component 124 can be implemented as part of the system 100 and configured to present the virtual documents 104 presented in the viewport 118 in combination with an interactive map 120, and apply visual emphasis 126 (e.g., colors, animations, object size, icons, fonts, etc.) to each of the (objects associated with the) points-of-interest 122 of the interactive map 120 and corresponding virtual documents 104 such that the POIs 122 are visually differentiated on the interactive map 120 and each point-of-interest (e.g., POI-1) is visually identified with a corresponding virtual document (e.g., virtual document 128) using the visual emphasis 126. For example, points-of-interest are represented as map objects (e.g., a circle) differentiated by size (e.g., larger and smaller circles based on result rank, relevance to query 110, etc.) and color. The virtual documents 104 and visual emphasis 126 provide for improved user efficiency and interaction performance in search.

The visual component 124 enables the presentation of and user interaction with multiple virtual documents (e.g., two or more) concurrently in the view port 118, and further enables the presentation of and interaction with the multiple virtual documents concurrently with a corresponding interactive map (e.g., map 120).

The multiple virtual documents 104 can each be presented in full view such that no document content of one virtual document is obscured by another virtual document (e.g., document 128 and first task document SR-12-TASK-1 are in full view). This enables the visual component 124 to present virtual documents concurrently with the corresponding interactive map 120 for visual perception and comparison of document content of a virtual document of search results (e.g., document 128), a virtual document of a result task (e.g., task document SR-12-TASK-1), and corresponding point-of-interest (e.g., POI-2) of the interactive map 124. Moreover, the visual component 124 can be configured to enable comparison of two or more of the virtual documents of a same session or a different session.

The visual component 124 can be an application or module separate from a system rendering or graphics application (e.g., as part of the operating system), that feeds the system rendering or graphics application instructions to present at least the virtual documents 104 and visual emphasis 126 in the desired ways. Alternatively, the virtual component 124 can be an application or module installed as part of the operating system for rendering the at least the virtual documents 104 and visual emphasis 126 in the desired ways.

In another implementation, the multiple virtual documents 104 can be presented in a combination of full and partial views based on the in-focus (the virtual document last interacted with by the user and in the foreground). For example, the in-focus virtual document is presented with no obscured content and the other (out-of-focus and in the background relative to the foreground document) virtual documents may have some document content partially viewable or entirely obscured from view, yet still enabling user selection of the virtual document to bring it into focus, if desired.

With reference to result tasks 108, the virtual document 128 can comprise interactive results that when selected enable the user to initiate result tasks related to the query 110. Here, two virtual documents are returned: the virtual document 128 and a second virtual document 130, both generated during the same search session.

A session can be defined as the time duration from a first user interaction (e.g., entry of the query 110) to a timeout time, or lack of user interaction. Thus, the user can perform multiple searches during a session, and likewise, multiple result tasks within each search session. Note that a session can be defined in other ways, as desired by the particular implementation. For example, alternatively, a session can defined as the time of the first interaction to the time of data storage of data returned from the query 110.

Returning to the figure, in the viewport 118, the user selects a second search result SR-12 (where SR is the particular search result, “1” indicates the first session, and “2” indicates the second result) of the virtual document 128 to perform the additional result tasks 108 presented as additional virtual documents: a first result task SR-12-TASK-1 as a virtual document, and a second result task SR-12-TASK-2 as a virtual document. The result tasks 108 are rendered (presented) with the virtual document of the first task in full view and the virtual document of the second task behind the first in partial view.

Thus, the query 110 can be a query for “pizza places in Bellevue”, which results in the search result virtual documents (128 and 130), and separate result tasks 108 for directions to the selected second pizza place result (SR-12) initiated by the user selecting the second result (SR-12). Additionally, the system 100 enables the viewing of both the search result document 128 and the virtual document of the first result task (SR-12-TASK-1), as well as the associated POI (e.g., POI-2) on the underlying interactive map 120. It can be the case that the first result task (SR-12-TASK-1) shows the directions to the pizza place form the current user location, and the second result task (SR-12-TASK-2) shows the website homepage of the pizza place.

The user can store the session and retrieve the session virtual documents as desired. Accordingly, the system 100 can further comprise a retrieval component 132 configured to retrieve and enable presentation of one or more of the search sessions and associated virtual documents for user interaction subsequent to the time of when the session was originally created. This capability also enables the sharing of sessions with other users (and systems) by sending the session file to another location (e.g., user location) and/or another user (e.g., a friend).

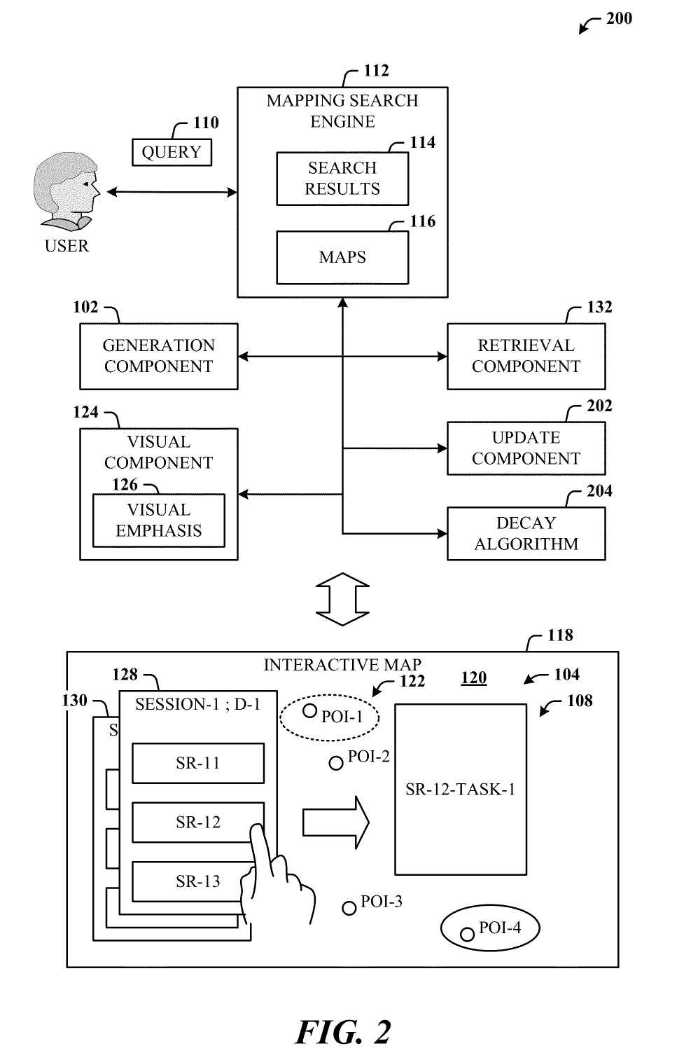

FIG. 2 illustrates an alternative implementation of a system 200 that further includes the capabilities for updates and feature decay. In this implementation, the system 200 comprises the items and component of the system 100 of FIG. 1. In addition, the system 200 comprises an update component 202 configured to update associated interactive virtual documents (e.g., document 128) in response to a change made to the interactive map 120 and to update the interactive map 120 in response to a change made to one or more of the associated interactive virtual documents (e.g., task document SR-12-TASK-1).

The system 200 can further comprise a decay algorithm 204 configured to control a number of the points-of-interest presented on the interactive map 120 using time decay to remove features (e.g., the POI-1) presented on the map 120. The decay algorithm can also be configured to retain a point-of-interest (e.g., POI-2) on the interactive map 120 in accordance with a permanence rule. A permanence rule defines specific criteria for either retaining or decaying a feature of the map 120. For example, a permanence rule can be to “retain a point-of-interest (e.g., POI-2) on the map 120 as long as the associated virtual document (“card”) is presented in the viewport 118”. Another example permanence rule can be to “remove the point-of interest associated with a search result virtual document when the search result virtual document is removed from the viewport 120”. Many other types of permanence rules can be created and implemented as part of the deployment and/or by the user.

The retrieval component 132 can also be configured to enable rendering of a previously decayed point-of-interest on the map 120 by bringing into focus a virtual document associated with the previously decayed point-of-interest. For example, consider that the search result virtual document 128 also included a fourth result SR-14 (not shown, but operationally scrollable into and out of view). Since there may be a rendering management criterion to only show at most three POIs (POI-1, POI-2, and POI-3) at a time on the map 120, the fourth point-of-interest POI-4 is not shown to avoid visual clutter and potential user confusion, thereby providing improved user efficiency and interaction performance.

However, when the user scrolls down the document 128 to the fourth result, the update component 202 automatically removes POI-1 from view (annotated for this description only as encircled with a dotted ellipse to show removed, since the corresponding result SR-11 is now scrolled out of view on the document 128) and brings the fourth point-of-interest POI-4 into view (annotated for this description only as encircled with a solid ellipse to show as viewable, since the corresponding result SR-14 would (but not shown) now be scrolled into view on the document 128) on the map 120.

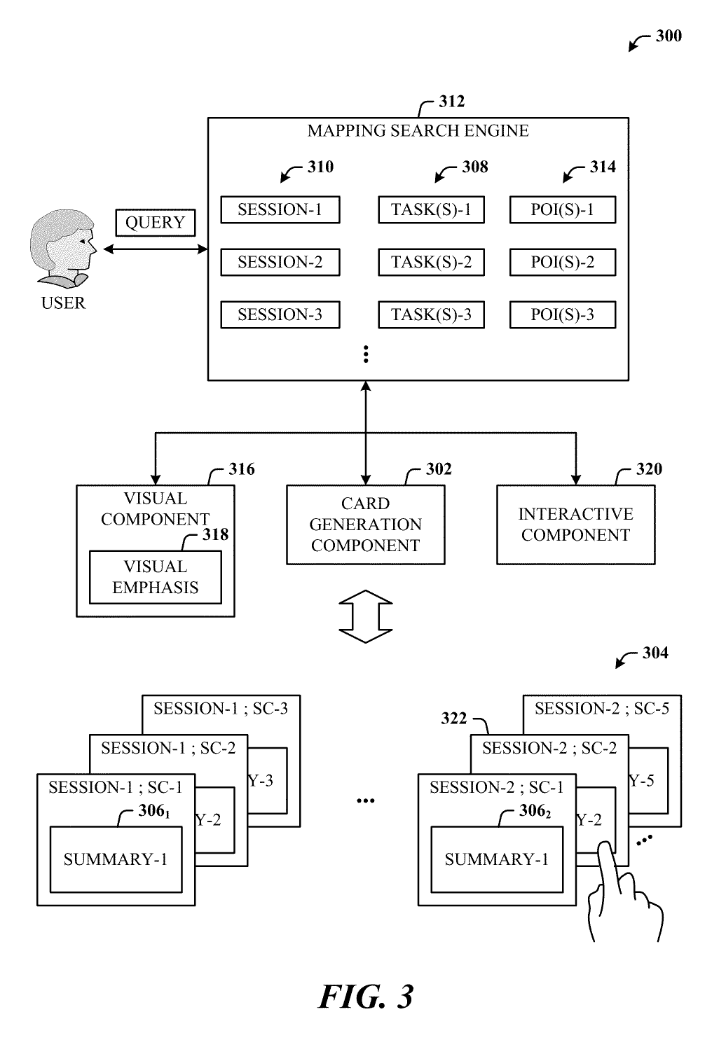

FIG. 3 illustrates an alternative system 300 in accordance with the disclosed architecture described in terms of virtual documents as semantic cards (where semantics is defined as determining/computing a meaning (e.g., of query term or terms) based on words, text, phrases, sentences, etc.). The system 300 can include a card generation component 302 (similar to generation component 102) configured to generate a set of interactive cards 304 (e.g., semantic cards) of summaries 306 (e.g., Summary-1 306₁ of Session-1, Summary-1 306₂ of Session-2, etc.) for each session task, for example, Task(s)-1 of a Session-1 (of search task(s) 308) performed for each of different search sessions 310 on a mapping search engine 312 (similar to mapping search engine 112). The search session tasks 308 are related to points-of-interest (POIs) 314 identified on one or more interactive maps (not shown, but similar to map 118) generated in response to user queries for map/POI information.

A visual component 316 (similar to visual component 124) is provided and configured to apply distinguishing visual emphasis 318 (e.g., coloration, bolding, object size, highlighting, font size, etc., and similar to the visual emphasis 126) to the points-of-interest 314 of the different search sessions 310 such that the points-of interest (POI(s)-1) of a first search session (Session-1) are visually distinguishable from the points-of-interest (e.g., POI(s)-2) of another search session (e.g., Session-2).

An interactive component 320 (similar to some capabilities of the retrieval component 132) can be provided and configured to enable retrieval of any one or more of the multiple search sessions 110 via interaction (e.g., touch via a touch display) with the corresponding semantic cards 304. Retrieval can be by the user interacting (via the interactive component 320) to cause selection of a specific semantic card, for example, a card 322 of the second session, Session-2.

In response, the mapping search engine 312 causes the rendering of the associated map, semantics cards, card content, map POIs, visual emphasis, and other desired information to be presented to the user as relates to the selected card 322 and the second session, in general. The view presented prior to the user interaction is then collapsed or reduced (minimized) in some way so that the user can then view the second session data, and more specifically, the mapping information that relates at least specifically to the card 322. The presentation enables the user to view some portion of identifying information or content of the cards 304 for perusal and/or selection.

It is to be understood that in the disclosed architecture, certain components may be rearranged, combined, omitted, and additional components may be included. Additionally, in some embodiments, all or some of the components are present on the client, while in other embodiments some components may reside on a server or are provided by a local or remote service.

The disclosed architecture can optionally include a privacy component that enables the user to opt in or opt out of exposing personal information such as preferences, location, search queries and results, etc. The privacy component enables the authorized and secure handling of user information, such as tracking information, as well as personal information that may have been obtained, is maintained, and/or is accessible. The user can be provided with notice of the collection of portions of the personal information and the opportunity to opt-in or opt-out of the collection process. Consent can take several forms. Opt-in consent can impose on the user to take an affirmative action before the data is collected. Alternatively, opt-out consent can impose on the user to take an affirmative action to prevent the collection of data before that data is collected.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

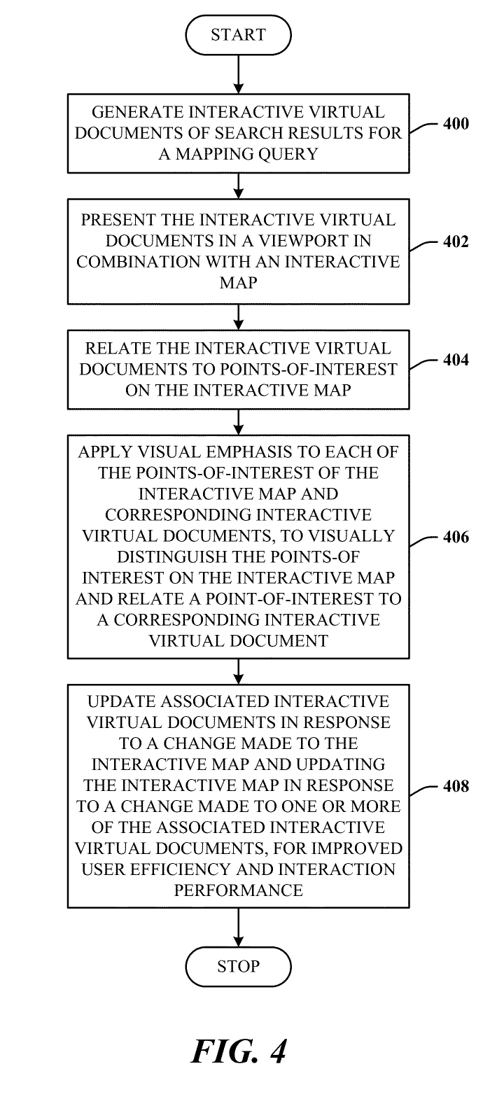

FIG. 4 illustrates a method in accordance with the disclosed architecture. At 400, interactive virtual documents (e.g., cards) of search results are generated for a mapping query. The mapping query can be for a point-of-interest such as a restaurant, a park, a building, and address, etc. At 402, the interactive virtual documents are presented in a viewport in combination with an interactive map. The viewport can be a bounded viewing area such as a window, which is generated by the device operating system or application, and in which the interactive map is also presented (e.g., as a background to the virtual documents).

At 404, the interactive virtual documents are related to points-of-interest on the interactive map. In other words, an internal program/data relationship is established such that there is a known link between the points-of-interest shown on the map and the virtual documents presented. At 406, visual emphasis is applied to each of the points-of-interest of the interactive map and corresponding interactive virtual documents. The visual emphasis is any application-generated graphics that can be applied to enable the viewer to readily identify the objects in the viewport.

For example, coloration, line bolding, line features (e.g., dots, dashes, etc.), highlighting of text, pointer hover actions (e.g., hover of the mouse point over a virtual document results in the associated point-of-interest to be animated in some why to quickly assist the user in identification of the point-of-interest, this can work in the reverse as well where hover over or near the point-of-interest will result in the associate virtual document(s) being presented in the foreground (or in-focus)), are examples of visual emphasis that can be utilized to assist the user to more quickly and intuitively identify a given point-of-interest is associated with a given virtual document or documents.

The applied visual emphasis enables the user to visually distinguish (e.g., by different colors) the points-of interest on the interactive map and relate a point-of-interest to a corresponding interactive virtual document.

At 408, associated interactive virtual documents are updated in response to a change (e.g., zoom-in, zoom-out, pan left or right, a selection interaction, etc.) made to the interactive map, and the interactive map updated in response to a change made to one or more of the associated interactive virtual documents, for improved user efficiency and interaction performance.

The method can further comprise an act of retrieving and presenting a prior search session that includes associated virtual documents of the prior session and interactive map of the prior session, for user interaction. This can be accomplished by enabling the storage of session information that enables the identification and retrieval of documents related to search results and tasks, as well as map tiles associated with the interactive map or maps generated for the prior session. The session information can include, but is not limited to, user information, time and date information, point-of interest, session filename, links to map tiles retrieved and presented during the session, virtual documents of results and result tasks generated for that session, queries input, and so on.

In an alternative implementation, once the session is retrieved, the session can be automatically updated by re-processing the query to obtain updated results for the given points-of-interest of the interactive map.

The method can further comprise presenting both a result virtual document of a search result and a task virtual document of a result task initiated from the result virtual document, concurrently, over the interactive map. One or both of the result virtual document and the task virtual document can be presented in a way so as to fully expose the document content(s). Thus, the documents are not presented as layered such that the user needs to move one document from behind another document in order to see content.

The method can further comprise limiting a count of the points-of-interest presented on the interactive map according to a predetermined count threshold. For example, the number of points-of-interest can be limited to a count of three, and even a fewer number of greater number depending on the device display capabilities. This can be made user-configurable as a preference, for example.

The method can further comprise returning to a prior interactive map and points-of-interest in response to selecting a prior virtual document associated with the prior interactive map. The prior interactive map can be returned (regenerated) from a current session or a prior session. In other words, given access to a virtual document, selection thereof will automatically reconstitute the interactive map and point-of-interest associated with the virtual document. In an alternative implementation, selection thereof will automatically reconstitute the state of the session at the point in time.

The method can further comprise applying different decay algorithms to correspondingly different features of the interactive map. A decay algorithm applies time decay to a specific feature or set of features of the map (map tiles). In this way, features on the interactive map can be phased-in or phased out of view in order to maintain the limited number of points-of-interest, for example, or to transition in or out of other features such as streets, routes, building, etc., on the map as the view changes (e.g., zoom-in, zoom-out, etc.).

The method can further comprise reprocessing the mapping query based on a change in view of the interactive map. For example, if the user performs a zoom operation on the map, the operation changes the view of map features as well. Thus, the mapping query can be re-processed to account for the change in map view and map features.

The method can further comprise retaining a point-of-interest on the interactive map in accordance with a permanence rule regardless of a change of view or a change in virtual documents. In other words, the permanence rule can be to keep the specific point-of-interest such that the rule is processed to overrides decay of that point-of-interest from the map. Thus, the point-of-interest is retained while other POIs may be decayed from view on the interactive map.

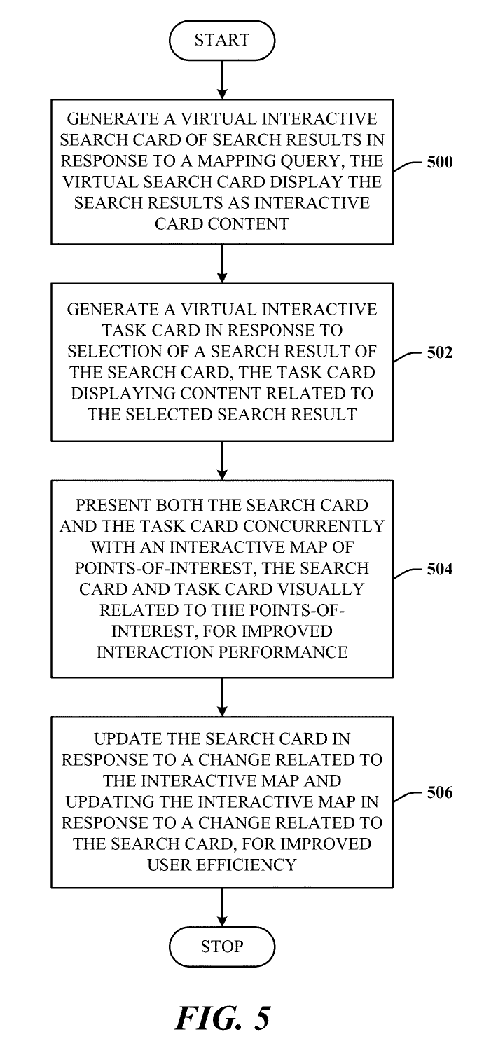

FIG. 5 illustrates an alternative method in accordance with the disclosed architecture. At 500, a virtual interactive search card of search results is generated in response to a mapping query. The virtual search card displays the search results as interactive card content. The interactive card content can be hyperlinked results as in conventional search result actions that navigate the user to another document.

At 502, a virtual interactive task card is generated in response to selection of a search result of the search card, the task card displaying content related to the selected search result. In other words, the user chooses to further investigate a search result for additional information. For example, a search result for a park can be further investigated for directions to the park. The task card then exposes (presents) the directions to the park. Although specifically referred to as a task card in this part of the description, the task card can be manifested more generally as a task affordance or task user interface (UI), or as a virtual document, as mentioned in other parts of this description.

At 504, both the search card and the task card are presented concurrently with an interactive map of points-of-interest. The search card and task card are visually related (e.g., by visual emphasis such as color) to the points-of-interest, for improved interaction performance.

At 506, the search card is updated in response to a change related to the interactive map and the interactive map is updated in response to a change related to the search card, for improved user efficiency. For example, if the user changes the map view to include a different point-of-interest, an associated search card can be retrieved and presented with information related to that different point-of-interest.

The method can further comprise limiting a count of the points-of-interest presented on the interactive map according to a predetermined count threshold, and phasing in or out of view on the interactive map a point-of-interest, based on the count threshold. This can be accomplished using one or more decay algorithms.

The method can further comprise applying a single visual emphasis to the search card, the task card, and corresponding points-of-interest to visually relate the search card, the task card, and corresponding points-of-interest to each other. The method can further comprise enabling visual comparison of the search card and the task card over the interactive map. This can be accomplished since two or more cards can be presented side-by-side.

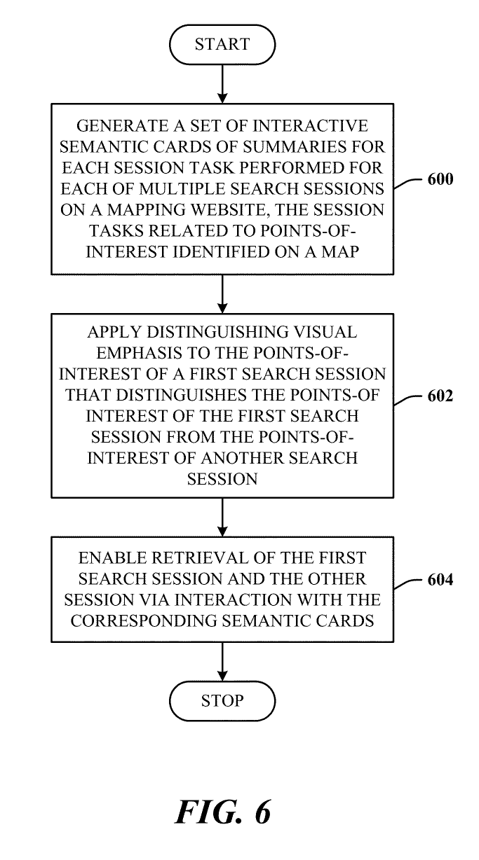

FIG. 6 illustrates yet another alternative method in accordance with the disclosed architecture. At 600, a set of interactive semantic cards of summaries is generated for each session task performed for each of multiple search sessions on a mapping website. The session tasks are related to points-of-interest identified on a map. At 602, distinguishing visual emphasis is applied to the points-of-interest of a first search session. The distinguishing visual emphasis distinguishes the points-of interest of the first search session from the points-of-interest of another search session. At 604, retrieval of the first search session and the other session is enabled via interaction with the corresponding semantic cards.

As used in this application, the terms “component” and “system” are intended to refer to a computer-related entity, either hardware, a combination of software and tangible hardware, software, or software in execution. For example, a component can be, but is not limited to, tangible components such as a microprocessor, chip memory, mass storage devices (e.g., optical drives, solid state drives, and/or magnetic storage media drives), and computers, and software components such as a process running on a microprocessor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

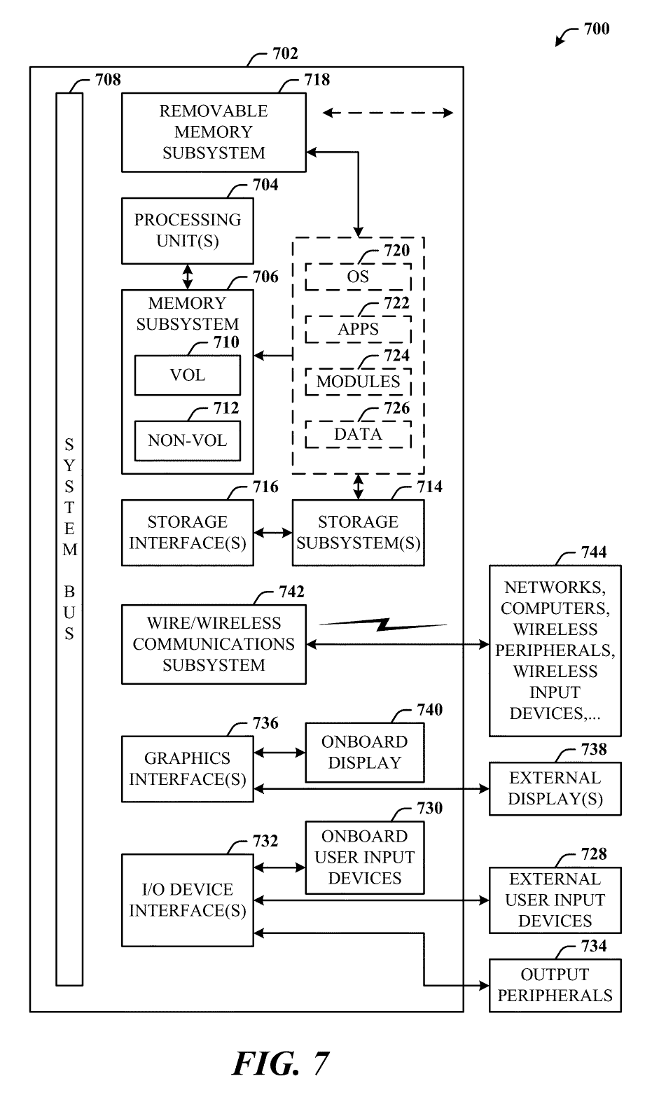

Referring now to FIG. 7, there is illustrated a block diagram of a computing system 700 that executes map multi-search in accordance with the disclosed architecture. Alternatively, or in addition, the functionally described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc., where analog, digital, and/or mixed signals and other functionality can be implemented in a substrate.

In order to provide additional context for various aspects thereof, FIG. 7 and the following description are intended to provide a brief, general description of the suitable computing system 700 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 700 for implementing various aspects includes the computer 702 having microprocessing unit(s) 704 (also referred to as microprocessor(s) and processor(s)), a computer-readable storage medium such as a system memory 706 (computer readable storage medium/media also include magnetic disks, optical disks, solid state drives, external memory systems, and flash memory drives), and a system bus 708. The microprocessing unit(s) 704 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 702 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 706 can include computer-readable storage (physical storage) medium such as a volatile (VOL) memory 710 (e.g., random access memory (RAM)) and a non-volatile memory (NON-VOL) 712 (e.g., ROM, EPROM, EEPROM, etc.). A basic input/output system (BIOS) can be stored in the non-volatile memory 712, and includes the basic routines that facilitate the communication of data and signals between components within the computer 702, such as during startup. The volatile memory 710 can also include a high-speed RAM such as static RAM for caching data.

The system bus 708 provides an interface for system components including, but not limited to, the system memory 706 to the microprocessing unit(s) 704. The system bus 708 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 702 further includes machine readable storage subsystem(s) 714 and storage interface(s) 716 for interfacing the storage subsystem(s) 714 to the system bus 708 and other desired computer components and circuits. The storage subsystem(s) 714 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 716 can include interface technologies such as EIDE, ATA, SATA, and IEEE 1394, for example.

One or more programs and data can be stored in the memory subsystem 706, a machine readable and removable memory subsystem 718 (e.g., flash drive form factor technology), and/or the storage subsystem(s) 714 (e.g., optical, magnetic, solid state), including an operating system 720, one or more application programs 722, other program modules 724, and program data 726.

The operating system 720, one or more application programs 722, other program modules 724, and/or program data 726 can include items and components of the system 100 of FIG. 1, items and components of the system 200 of FIG. 2, items and components of the system 300 of FIG. 3, and the methods represented by the flowcharts of FIGS. 4-6, for example.

Generally, programs include routines, methods, data structures, other software components, etc., that perform particular tasks, functions, or implement particular abstract data types. All or portions of the operating system 720, applications 722, modules 724, and/or data 726 can also be cached in memory such as the volatile memory 710 and/or non-volatile memory, for example. It is to be appreciated that the disclosed architecture can be implemented with various commercially available operating systems or combinations of operating systems (e.g., as virtual machines).

The storage subsystem(s) 714 and memory subsystems (706 and 718) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 702, and include volatile and non-volatile internal and/or external media that is removable and/or non-removable. For the computer 702, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 702, programs, and data using external user input devices 728 such as a keyboard and a mouse, as well as by voice commands facilitated by speech recognition. Other external user input devices 728 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 702, programs, and data using onboard user input devices 730 such a touchpad, microphone, keyboard, etc., where the computer 702 is a portable computer, for example.

These and other input devices are connected to the microprocessing unit(s) 704 through input/output (I/O) device interface(s) 732 via the system bus 708, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 732 also facilitate the use of output peripherals 734 such as printers, audio devices, camera devices, and so on, such as a sound card and/or onboard audio processing capability.

One or more graphics interface(s) 736 (also commonly referred to as a graphics processing unit (GPU)) provide graphics and video signals between the computer 702 and external display(s) 738 (e.g., LCD, plasma) and/or onboard displays 740 (e.g., for portable computer). The graphics interface(s) 736 can also be manufactured as part of the computer system board.

The computer 702 can operate in a networked environment (e.g., IP-based) using logical connections via a wired/wireless communications subsystem 742 to one or more networks and/or other computers. The other computers can include workstations, servers, routers, personal computers, microprocessor-based entertainment appliances, peer devices or other common network nodes, and typically include many or all of the elements described relative to the computer 702. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 702 connects to the network via a wired/wireless communication subsystem 742 (e.g., a network interface adapter, onboard transceiver subsystem, etc.) to communicate with wired/wireless networks, wired/wireless printers, wired/wireless input devices 744, and so on. The computer 702 can include a modem or other means for establishing communications over the network. In a networked environment, programs and data relative to the computer 702 can be stored in the remote memory/storage device, as is associated with a distributed system. It will be appreciated that the network connections shown are exemplary and other means of establishing a communications link between the computers can be used.

The computer 702 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

The disclosed architecture can be implemented as a system, comprising: means for generating interactive virtual documents of search results for a mapping query; means for presenting the interactive virtual documents in a viewport in combination with an interactive map; means for relating the interactive virtual documents to points-of-interest on the interactive map; means for applying visual emphasis to each of the points-of-interest of the interactive map and corresponding interactive virtual documents, to visually distinguish the points-of interest on the interactive map and relate a point-of-interest to a corresponding interactive virtual document; and means for updating associated interactive virtual documents in response to a change made to the interactive map and updating the interactive map in response to a change made to one or more of the associated interactive virtual documents, for improved user efficiency and interaction performance.

The disclosed architecture can also be implemented as a system, comprising: means for generating a virtual interactive search card of search results in response to a mapping query, the virtual search card displays the search results as interactive card content; means for generating a virtual interactive task card in response to selection of a search result of the search card, the task card displaying content related to the selected search result; means for presenting both the search card and the task card concurrently with an interactive map of points-of-interest, the search card and task card visually related to the points-of-interest, for improved interaction performance; and, means for updating the search card in response to a change related to the interactive map and updating the interactive map in response to a change related to the search card, for improved user efficiency.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a generation component configured to generate interactive virtual documents of search results and result tasks for a mapping query, the virtual documents relate to points-of-interest (POIs) identified on the interactive map;
a visual component configured to present the virtual documents in a viewport in combination with an interactive map, and apply visual emphasis to each of the points-of-interest of the interactive map and corresponding virtual documents such that the POIs are visually differentiated on the interactive map and each point-of-interest is visually identified with a corresponding virtual document using the visual emphasis, the virtual documents and visual emphasis provided for improved user efficiency and interaction performance;
a retrieval component configured to retrieve and enable presentation of one or more of the search sessions and associated virtual documents for user interaction; and
at least one hardware processor configured to execute computer-executable instructions in a memory associated with the generation component, the visual component, and the retrieval component.

2. The system of claim 1, further comprising an update component configured to update associated interactive virtual documents in response to a change made to the interactive map and to update the interactive map in response to a change made to one or more of the associated interactive virtual documents.

3. The system of claim 1, wherein the visual component is configured to present virtual documents concurrently with the corresponding interactive map to enable visual perception and comparison of document content of a virtual document of search results, a virtual document of a result task, and corresponding point-of-interest.

4. The system of claim 1, further comprising a decay algorithm configured to control a number of the points-of-interest presented on the interactive map using time decay to remove features presented on the map.

5. The system of claim 4, wherein the decay algorithm is configured to retain a point-of-interest on the interactive map in accordance with a permanence rule.

6. The system of claim 1, wherein the retrieval component is configured to enable rendering of a previously decayed point-of-interest on the map by bringing into focus a virtual document associated with the previously decayed point-of-interest.

7. The system of claim 1, wherein the points-of-interest are represented as map objects differentiated by size and color.

8. The system of claim 1, wherein the visual component is configured to enable comparison of two or more of the virtual documents of a same session or a different session.

9. A method, comprising acts of:
generating interactive virtual documents of search results for a mapping query;
presenting the interactive virtual documents in a viewport in combination with an interactive map;
relating the interactive virtual documents to points-of-interest on the interactive map;
applying visual emphasis to each of the points-of-interest of the interactive map and corresponding interactive virtual documents, to visually distinguish the points-of interest on the interactive map and relate a point-of-interest to a corresponding interactive virtual document; and
updating associated interactive virtual documents in response to a change made to the interactive map and updating the interactive map in response to a change made to one or more of the associated interactive virtual documents, for improved user efficiency and interaction performance.

10. The method of claim 9, further comprising retrieving and presenting a prior search session that includes associated virtual documents of the prior session and interactive map of the prior session, for user interaction.

11. The method of claim 9, further comprising presenting both a result virtual document of a search result and a task virtual document of a result task initiated from the result virtual document, concurrently, over the interactive map.

12. The method of claim 9, further comprising limiting a count of the points-of-interest presented on the interactive map according to a predetermined count threshold.

13. The method of claim 9, further comprising returning to a prior interactive map and points-of-interest in response to selecting a prior virtual document associated with the prior interactive map, the prior interactive map returned from a current session or a prior session.

14. The method of claim 9, further comprising applying different decay algorithms to correspondingly different features of the interactive map.

15. The method of claim 9, further comprising reprocessing the mapping query based on a change in view of the interactive map.

16. The method of claim 9, further comprising retaining a point-of-interest on the interactive map in accordance with a permanence rule regardless a change of view or a change in virtual documents.

17. A method, comprising acts of:
generating a virtual interactive search card of search results in response to a mapping query, the virtual search card displays the search results as interactive card content;
generating a virtual interactive task card in response to selection of a search result of the search card, the task card displaying content related to the selected search result;
presenting both the search card and the task card concurrently with an interactive map of points-of-interest, the search card and task card visually related to the points-of-interest, for improved interaction performance; and
updating the search card in response to a change related to the interactive map and updating the interactive map in response to a change related to the search card, for improved user efficiency.

18. The method of claim 17, further comprising limiting a count of the points-of-interest presented on the interactive map according to a predetermined count threshold, and phasing in or out of view on the interactive map a point-of-interest, based on the count threshold.

19. The method of claim 17, further comprising applying a single visual emphasis to the search card, the task card, and corresponding points-of-interest to visually relate the search card, the task card, and corresponding points-of-interest to each other.

20. The method of claim 17, further comprising enabling visual comparison of the search card and the task card over the interactive map.
